(19) United States
(12) Patent Application Publication
(10) Pub. No.: US 2023/0009271 A1
(43) Pub. Date: Jan. 12, 2023

(54) FIBER-OPTIC FABRY-PEROT PRESSURE SENSOR AND BATCH PREPARATION METHOD FOR SENSING UNIT THEREOF

(71) Applicant: NORTH UNIVERSITY OF CHINA, Taiyuan (CN)

(72) Inventors: Pinggang Jia, Taiyuan (CN); Jijun Xiong, Taiyuan (CN); Jiashun Li, Taiyuan (CN); Guocheng Fang, Taiyuan (CN); Jia Liu, Taiyuan (CN); Guowen An, Taiyuan (CN); Ting Liang, Taiyuan (CN)

(73) Assignee: NORTH UNIVERSITY OF CHINA, Taiyuan (CN)

(21) Appl. No.: 17/811,094

(22) Filed: Jul. 7, 2022

(30) Foreign Application Priority Data
Jul. 7, 2021 (CN) 202110769703.0
Jul. 7, 2021 (CN) 202110769704.5

(51) Int. Cl. G01L 9/00

(52) U.S. Cl. CPC G01L 9/0079

(57) ABSTRACT

Some embodiments of the disclosure provides a method for preparing a sensing unit of a fiber-optic Fabry-Perot pressure sensor. The method includes the following steps. Preparing a first quartz sheet and a second quartz sheet, polishing the upper surface of the first quartz sheet, and polishing the upper surface of the second quartz sheet. Fabricating a plurality of grooves in the upper surface of the first quartz sheet. Fabricating through holes in the lower surface of the first quartz sheet, each of the through holes being coaxial with a corresponding groove and communicating with the corresponding groove. Combining the upper surface of the second quartz sheet with the upper surface of the first quartz sheet to form a laminated body. Cutting the plurality of grooves of the laminated body to obtain a plurality of sensing units.

### CROSS REFERENCE TO RELATED APPLICATIONS

This application claims priority to Chinese Patent Application No. 202110769703.0, filed on Jul. 7, 2021, and to Chinese Patent Application No. 202110769704.5, filed on Jul. 7, 2021, the disclosure of which are incorporated by reference herein in their entireties.

### FIELD OF THE DISCLOSURE

The disclosure relates generally to the field of pressure sensors. More specifically, the disclosure relates to fiber-optic Fabry-Perot pressure sensors and preparation methods for sensing units thereof.

### BACKGROUND

In recent years, with the rapid development in the fields such as aerospace, chemical industry and energy sources, the demand on the reliability of a pressure sensor used in high-temperature environment has been higher and higher. It is difficult for a traditional piezoresistive or piezoelectric pressure sensor to perform high-precision pressure measurement in the above-mentioned fields due to the problems such as no high temperature tolerance of a fabricating material and adverse impacts of thermal conduction of signal lines to a demodulation system.

A fiber-optic type pressure sensor, such as a fiber-optic Fabry-Perot pressure sensor, generally senses a pressure by means of a sensing unit based on an optical principle and has the advantages such as small size, high sensitivity, corrosion resistance and anti-electromagnetic interference. The sensing unit may be fabricated of a material resistant to high temperature, and the application of the above-mentioned optical principle is not easily affected by high temperature, so that the fiber-optic Fabry-Perot pressure sensor is applicable for pressure measurement in the above-mentioned high-temperature environment. In recent years, technologies for manufacturing the fiber-optic Fabry-Perot pressure sensor mainly include MEMS technology, chemical corrosion technology, arc discharging technology, laser processing technology and the like. However, the sensors manufactured by using the chemical corrosion technology, the arc discharging technology and the laser processing technology are relatively poor in consistency. For example, the thicknesses and effective radii of sensing diaphragms of different sensing units are inconsistent, so that the consistency of the sensing units is relatively low, and it is difficult to realize the low-cost batch manufacture of the sensors.

On the contrary, the sensor manufactured by using MEMS technology has the advantages of high consistency and batch manufacture of the sensing unit. A pressure sensor has been reported at present, the batch manufacture of the fiber-optic Fabry-Perot pressure sensor has been achieved by using a Pyrex glass wafer and a silicon wafer, and such sensors are able to do pressure measurements in 350° C. high-temperature environment, however, due to the restriction from characteristics of the material itself, it is difficult for such sensors to achieve pressure measurement in a higher-temperature environment. Moreover, the sensors are fabricated of two materials with different thermal expansion coefficients respectively, the usage performance of the sensors may be affected by unmatched thermal expansion coefficients of the different materials when the sensors work in the high-temperature environment, which also restricts the application of such sensors in high temperature scenario. Moreover, a relatively common method for connecting a fiber-optic and a sensing unit is to utilize ultraviolet epoxy resin or a high-temperature-resistant adhesive, binding material introduced to the sensor working in high-temperature environment may further impact the stability and service life of the sensor at high temperature.

A fused quartz glass material has a softening point reaching up to about 1730° C. and is resistant to acid and alkali; compared with the current common material, such as metal, Pyrex glass, silicon, sapphire and SiC, used for fabricating the fiber-optic Fabry-Perot pressure sensor, quartz material is lower in thermal expansion coefficient so as to be good material for fabricating a high-temperature pressure sensor. In the present disclosure, a full-quartz fiber-optic Fabry-Perot pressure sensor which may be manufactured in batches is manufactured and verified by using a high-temperature thermal compression bonding technology and a micromachining technology, and the glue-free sealing integration of a full-quartz sensing unit and a signal transmission fiber-optic of the sensor is achieved by using a CO₂ laser fusion technology, so that such a sensor is able to work stably in the high-temperature environment.

### SUMMARY

The following presents a simplified summary of the invention in order to provide a basic understanding of some aspects of the invention. This summary is not an extensive overview of the invention. It is not intended to identify critical elements or to delineate the scope of the invention. Its sole purpose is to present some concepts of the invention in a simplified form as a prelude to the more detailed description that is presented elsewhere.

The present disclosure is proposed in view of the situation in the prior art and aims at providing a batch preparation method for a sensing unit of a fiber-optic Fabry-Perot pressure sensor, by which the consistency of fiber-optic Fabry-Perot pressure sensors may be improved.

In some embodiments, the present disclosure provides a batch preparation method for a sensing unit of a fiber-optic Fabry-Perot pressure sensor, including the following steps. Preparing a first quartz sheet with an upper surface and a lower surface which are opposite and a second quartz sheet with an upper surface and a lower surface which are opposite, polishing the upper surface of the first quartz sheet, and polishing the upper surface of the second quartz sheet. Fabricating a plurality of grooves in the upper surface of the first quartz sheet. Fabricating through holes in positions corresponding to each of all the grooves in the lower surface of the first quartz sheet which are coaxial with the corresponding each of all the grooves and communicating with the corresponding each of all the grooves. Combining the upper surface of the second quartz sheet with the upper surface of the first quartz sheet in a manner of covering the plurality of grooves to form a laminated body. Cutting the plurality of grooves of the laminated body to obtain a plurality of sensing units.

In the above-mentioned batch preparation method, the first quartz sheet and the second quartz sheet are machined to obtain the plurality of sensing units, and thus, the material consistency of all the sensing units may be improved. In addition, the second quartz sheet is combined with the first quartz sheet in a manner of covering the plurality of grooves of the first quartz sheet to form the laminated body, and the plurality of grooves of the laminated body are cut to obtain the plurality of sensing units, so that the consistency of sensing diaphragms of all the sensing units may be improved. Therefore, the consistency of the sensing units may be improved, and then, the consistency of the fiber-optic Fabry-Perot pressure sensors may be improved.

In addition, the present disclosure further provides a fiber-optic Fabry-Perot pressure sensor including a sensing unit and a fiber-optic. The sensing unit includes a first inner surface, a second inner surface opposite to the first inner surface, a cavity formed between the first inner surface and the second inner surface and a through hole communicating with the cavity via the second inner surface. A size of the fiber-optic matches a size of the through hole, and the fiber-optic is embedded in the through hole. An axis of the fiber-optic is orthogonal to the first inner surface, and the end surface of the end of the fiber-optic embedded in the through hole is parallel to the first inner surface. A light ray entering the cavity via the fiber-optic may be reflected between the end surface of the end of the fiber-optic embedded in the through hole and the first inner surface. The sensing unit is prepared by using the batch preparation method according to the first aspect of the present disclosure. In such a case, a plurality of sensing units are prepared by using the batch preparation method according to the first aspect of the present disclosure, fiber-optic Fabry-Perot pressure sensors are further prepared, and thus, the consistency of the fiber-optic Fabry-Perot pressure sensors may be improved.

In addition, the present disclosure further provides a high-consistency preparation method for a sensing unit of a fiber-optic Fabry-Perot pressure sensor, including the following steps. Preparing a first quartz sheet with an upper surface and a lower surface which are opposite, a second quartz sheet with an upper surface and a lower surface which are opposite and a third quartz sheet with an upper surface and a lower surface which are opposite. Polishing the upper surface of the first quartz sheet, polishing the upper surface and the lower surface of the second quartz sheet, and polishing the upper surface of the third quartz sheet. Fabricating a plurality of grooves in the upper surface of the first quartz sheet or the upper surface of the second quartz sheet in a predetermined distribution manner. Fabricating a plurality of through holes in the third quartz sheet in a predetermined distribution manner. Combining the upper surface of the second quartz sheet with the upper surface of the first quartz sheet in a manner of covering the plurality of grooves, and combining the upper surface of the third quartz sheet with the lower surface of the second quartz sheet, thereby forming a laminated body of which all the grooves and all the through holes are coaxial respectively. Cutting the plurality of grooves to obtain a plurality of sensing units.

In the above-mentioned high-consistency preparation method, the first quartz sheet, the second quartz sheet, and the third quartz sheet are machined to obtain the plurality of sensing units, and thus, the material consistency of all the sensing units may be improved. In addition, the laminated body may be formed by combining the first quartz sheet with the second quartz sheet in a manner of covering the plurality of grooves and combining the third quartz sheet with the second quartz sheet, and the plurality of grooves of the laminated body are cut to obtain the plurality of sensing units, so that the consistency of sensing diaphragms of all the sensing units may be improved. Therefore, the consistency of the sensing units may be improved, and then, the consistency of fiber-optic Fabry-Perot pressure sensors is improved.

In addition, the present disclosure further provides another fiber-optic Fabry-Perot pressure sensor including a sensing unit and a fiber-optic. The sensing unit includes a first diaphragm, a second diaphragm and a third diaphragm which are sequentially laminated. A microcavity is formed between the first diaphragm and the second diaphragm, a first reflecting surface and a second reflecting surface respectively located on two opposite sides of the microcavity are parallel to each other. A through hole coaxial with the microcavity and not communicating with the microcavity is formed in the third diaphragm. The size of the fiber-optic is matched with the size of the through hole, and the fiber-optic is embedded in the through hole. An axis of the fiber-optic is orthogonal to the first reflecting surface and the second reflecting surface. A ray entering the microcavity via the fiber-optic may be reflected between the first reflecting surface and the second reflecting surface. The sensing unit is prepared by using the high-consistency preparation method according to the first aspect of the present disclosure. In such a case, a plurality of sensing units are prepared by using the high-consistency preparation method according to the first aspect of the present disclosure, fiber-optic Fabry-Perot pressure sensors are further prepared, and thus, the consistency of the fiber-optic Fabry-Perot pressure sensors may be improved.

In some embodiments, the disclosure provides a method for preparing a sensing unit of a fiber-optic Fabry-Perot pressure sensor. The method includes the following steps.

Preparing a first quartz sheet with an upper surface and a lower surface and a second quartz sheet with an upper surface and a lower surface, polishing the upper surface of the first quartz sheet, and polishing the upper surface of the second quartz sheet.

Fabricating a plurality of grooves in the upper surface of the first quartz sheet.

Fabricating through holes in the lower surface of the first quartz sheet, each of the through holes being coaxial with a corresponding groove of the plurality of the grooves and communicating with the corresponding groove of the plurality of the grooves.

Combining the upper surface of the second quartz sheet with the upper surface of the first quartz sheet in a manner of covering the plurality of grooves to form a laminated body.

Cutting the laminated body at the plurality of grooves to obtain a plurality of sensing units.

Optionally, bosses are fabricated on the lower surface of the first quartz sheet of the laminated body, each of the bosses being coaxial with a corresponding through hole of the through holes.

Optionally, in the laminated body, axes of the through holes are perpendicular to the upper surface of the second quartz sheet.

Optionally, a plurality of air holes are fabricated in the lower surface of the second quartz sheet of the laminated body, each of the plurality of the air holes communicating with a corresponding groove of the plurality of the grooves.

In other embodiments, the disclosure provides a fiber-optic Fabry-Perot pressure sensor including a sensing unit and a fiber-optic.

The sensing unit includes a first inner surface, a second inner surface opposite to the first inner surface, a cavity formed between the first inner surface and the second inner surface, and a through hole communicating with the cavity via the second inner surface.

The size of the fiber-optic matches the size of the through hole and the fiber-optic is embedded in the through hole.

The axis of the fiber-optic is orthogonal to the first inner surface and an end surface of the fiber-optic is parallel to the first inner surface, the end of the fiber-optic being embedded in the through hole.

A light ray entering the cavity via the fiber-optic is reflected between the end surface of the fiber-optic and the first inner surface.

In further embodiments, the disclosure provides a method for preparing a sensing unit of a fiber-optic Fabry-Perot pressure sensor. The method includes the following steps.

Preparing a first quartz sheet with an upper surface and a lower surface, a second quartz sheet with an upper surface and a lower surface, and a third quartz sheet with an upper surface and a lower surface.

Polishing the upper surface of the first quartz sheet, polishing the upper surface and the lower surface of the second quartz sheet, and polishing the upper surface of the third quartz sheet.

Fabricating a plurality of grooves in the upper surface of the first quartz sheet or the upper surface of the second quartz sheet in a predetermined distribution manner.

Fabricating a plurality of through holes in the third quartz sheet in the predetermined distribution manner.

Combining the upper surface of the second quartz sheet with the upper surface of the first quartz sheet in a manner of covering the plurality of grooves and combining the upper surface of the third quartz sheet with the lower surface of the second quartz sheet, thereby forming a laminated body of which all the grooves and all the through holes are respectively coaxial.

Cutting the laminated body at the plurality of grooves to obtain a plurality of sensing units.

Optionally, the predetermined distribution manner includes an axial distance between grooves.

Optionally, the method further includes fabricating bosses on the lower surface of the third quartz sheet of the laminated body. Each of the bosses is coaxial with a corresponding through hole of the through holes, the bosses are cylindrical. Diameters of the bosses are smaller than 2.5 mm.

Optionally, a plurality of air holes passing by the first quartz sheet and communicating with the grooves are fabricated in the laminated body.

Optionally, the plurality of air holes are L-shaped.

Optionally, the plurality of air holes are uniformly disposed around axes of the through holes.

In some embodiments, the disclosure provides a fiber-optic Fabry-Perot pressure sensor, including a sensing unit and a fiber-optic.

The sensing unit includes a first diaphragm, a second diaphragm, and a third diaphragm which are sequentially laminated.

A microcavity is formed between the first diaphragm and the second diaphragm, a first reflecting surface and a second reflecting surface being respectively located on two opposite sides of the microcavity and being parallel to each other.

A through hole coaxial with the microcavity and not communicating with the microcavity is formed in the third diaphragm.

The size of the fiber-optic matches the size of the through hole and the fiber-optic is embedded in the through hole.

The axis of the fiber-optic is orthogonal to the first reflecting surface and the second reflecting surface.

A light ray entering the microcavity via the fiber-optic is reflected between the first reflecting surface and the second reflecting surface.

Optionally, the fiber-optic includes a naked fiber-optic and a glass tube with a hollow part, the size of the glass tube matches the size of the through hole, and the glass tube is embedded in the through hole.

The size of the naked fiber-optic matches the size of the hollow part and the naked fiber-optic is embedded in the hollow part. The axis of the hollow part is orthogonal to the first reflecting surface and the second reflecting surface. The end surface of the naked fiber-optic is parallel to the first reflecting surface and the second reflecting surface, the end of the naked fiber-optic being embedded in the hollow part.

Optionally, the end surface of the fiber-optic is provided with a collimating element configured to collimate a light ray, the end of the fiber-optic being embedded in a hollow part of a glass tube.

### BRIEF DESCRIPTION OF THE DRAWINGS

Illustrative embodiments of the present disclosure are described in detail below with reference to the figures.

FIG. 1A schematically shows a stereoscopic view of a nonrestrictive example of a pressure sensor according to various embodiments of the disclosure.

FIG. 1B shows a sectional view of a sensing unit in FIG. 1A along a direction AA′.

FIG. 2A schematically shows a stereoscopic view of a nonrestrictive example of the sensing unit according to various embodiments of the disclosure.

FIG. 2B shows a sectional view of the sensing unit in FIG. 2A along a direction BB′.

FIG. 3A schematically shows a stereoscopic view of another nonrestrictive example of the sensing unit according to various embodiments of the disclosure.

FIG. 3B shows a sectional view of the sensing unit in FIG. 3A along a direction CC′.

FIG. 4 schematically shows a flow chart of a nonrestrictive example of a batch preparation method according to various embodiments of the disclosure.

FIG. 5A schematically shows a stereoscopic view of a nonrestrictive example of a first quartz sheet and a second quartz sheet according to various embodiments of the disclosure.

FIG. 5B schematically shows that grooves are fabricated in the first quartz sheet according to various embodiments of the disclosure.

FIG. 5C schematically shows that through holes are fabricated in the first quartz sheet according to various embodiments of the disclosure.

FIG. 5D schematically shows a nonrestrictive example of a laminated body according to various embodiments of the disclosure.

FIG. 5E schematically shows that bosses are fabricated on the laminated body according to various embodiments of the disclosure.

FIG. 5F schematically shows that the laminated body is cut according to various embodiments of the disclosure.

FIG. 6A schematically shows a stereoscopic view of another nonrestrictive example of a pressure sensor according to various embodiments of the disclosure.

FIG. 6B shows a sectional view of a sensing unit in FIG. 6A along a direction DD′.

FIG. 6C shows a sectional view of the pressure sensor in FIG. 6A along the direction DD′.

FIG. 6D schematically shows a sectional view of a nonrestrictive example of the pressure sensor according to various embodiments of the disclosure.

FIG. 6E schematically shows a sectional view of another nonrestrictive example of the pressure sensor according to various embodiments of the disclosure.

FIG. 7 schematically shows a flow chart of a nonrestrictive example of a high-consistency preparation method according to various embodiments of the disclosure.

FIG. 8A schematically shows a stereoscopic view of a nonrestrictive example of a first quartz sheet, a second quartz sheet, and a third quartz sheet according to various embodiments of the disclosure.

FIG. 8B schematically shows that grooves are fabricated in the second quartz sheet according to various embodiments of the disclosure.

FIG. 8C schematically shows that through holes are fabricated in the first quartz sheet according to various embodiments of the disclosure.

FIG. 8D schematically shows a nonrestrictive example of a laminated body according to various embodiments of the disclosure.

FIG. 8E schematically shows that bosses are fabricated on the laminated body according to various embodiments of the disclosure.

### DETAILED DESCRIPTION

The following describes some non-limiting embodiments of the invention with reference to the accompanying drawings. The described embodiments are merely a part rather than all of the embodiments of the invention. All other embodiments obtained by a person of ordinary skill in the art based on the embodiments of the disclosure shall fall within the scope of the disclosure.

As below, the preferred embodiments of the present disclosure will be described in detail with reference to the accompanying drawings. In the following description, the same component is endowed with the same numeral, and repeated descriptions are omitted. In addition, the accompanying drawings are only schematic views, the proportion of the size among the components or the shapes of the components and the like may be different from those in reality.

It should be noted that terms “include” and “have” in the present disclosure and any variants thereof, such as a process, method, system, product or device including or having a series of steps or units, are unnecessarily limited to the clearly listed steps or units, but may include other steps or units which are not clearly listed or are inherent for the process, method, product or device.

In addition, the subtitle involved to the following description of the present disclosure is only intended to play a role in reading prompt, rather than to limit the content or scope of the present disclosure. Such a subtitle should not be understood as a content for segmenting the article, and the content of the subtitle should not be only limited within the scope of the subtitle.

Various embodiments of the present disclosure relate to a fiber-optic Fabry-Perot pressure sensor. Various embodiments of the present disclosure further relate to a batch preparation method for a sensing unit of a fiber-optic Fabry-Perot pressure sensor. By using the preparation method in the present embodiments, the consistency of sensing units of pressure sensors may be improved, and thus, the consistency of the pressure sensors may be improved.

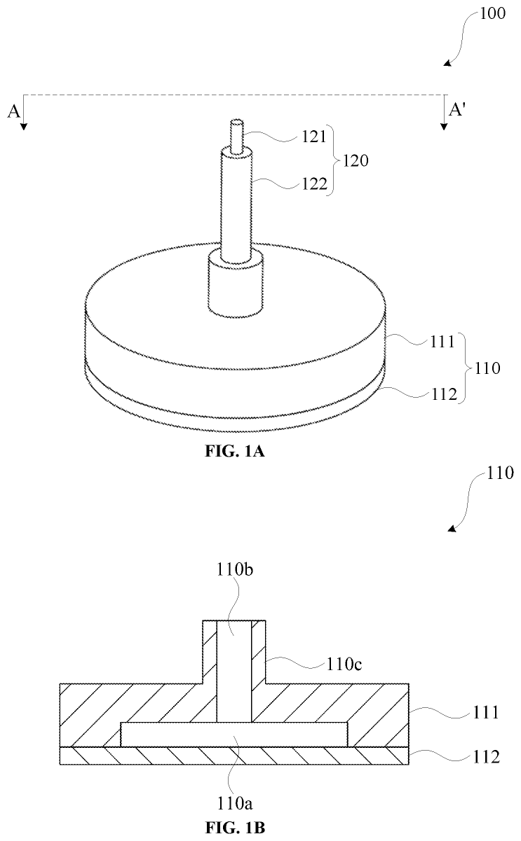

FIG. 1A schematically shows a stereoscopic view of a nonrestrictive example of a pressure sensor 100 according to various embodiments of the present disclosure; and FIG. 1B shows a sectional view of a sensing unit 110 in FIG. 1A along a direction AA′.

In the present embodiment, a pressure sensor 100 may include a sensing unit 110 and an optical component 120 connected with the sensing unit 110 (with reference to FIG. 1A). A Fabry-Perot cavity may be formed by matching the sensing unit 110 and the optical component 120, pressure may be sensed by the sensing unit 110, and a sensing signal of the pressure may be obtained through the cooperation of the optical component 120 and the sensing unit 110. In some examples, the optical component 120 may be connected with a demodulation device (unshown) used to demodulate the sensing signal and transmit the sensing signal to the demodulation device, and the demodulation device may demodulate the sensing signal, thereby obtaining a measurement result of the pressure.

In the present embodiment, the Fabry-Perot cavity may refer to an optical resonant cavity consisting of two light guide surfaces which are disposed oppositely parallel to each other and spaced from each other for a predetermined distance, and a light ray may be reflected between the two light guide surfaces of the Fabry-Perot cavity, thereby generating optical feedback. In the Fabry-Perot cavity, there is a corresponding relation between the optical feedback generated when the light ray is reflected between the two light guide surfaces and the distance between the two light guide surfaces.

In some examples, the sensing unit 110 may include a base 111 and a sensing diaphragm 112 (with reference to FIG. 1A and FIG. 1B). In some examples, the base 111 may have a groove structure 110a and a through hole structure 110b, the sensing diaphragm 112 may be combined with the base 111 in a manner of covering the groove structure 110a of the base 111, and a cavity is thus formed (with reference to FIG. 1B). In addition, in some examples, the base 111 may further have a boss structure 110c (with reference to FIG. 1B), and the boss structure 110c may be penetrated by the through hole structure 110b.

In addition, in some examples, the surface, close to the groove structure 110a, of the sensing diaphragm 112 may be polished.

In some examples, an end surface of the optical component 120 may be a smooth surface and may be placed into the through hole structure 110b (with reference to FIG. 1A). In such a case, the surface, close to the groove structure 110a, of the sensing diaphragm 112 may be used as a first light guide surface, and the end surface, close to the sensing diaphragm 112 of the optical component 120 may be used as a second light guide surface, and the cavity, the first light guide surface and the second light guide surface may form the Fabry-Perot cavity described herein.

When the pressure sensor 100 related to the present embodiment is used to measure a pressure, the sensing diaphragm 112 may deform due to the pressure so as to change the distance between the first light guide surface (i.e. the surface of the sensing diaphragm 112 facing the groove structure 110a) and the second light guide surface (i.e. the end surface of the optical component 120 facing the sensing diaphragm 112), and thus, the optical feedback generated as the light ray is reflected between the first light guide surface and the second light guide surface may be changed. The demodulation device may obtain the distance between the first light guide surface and the second light guide surface based on the changed optical feedback, so that the deformation generated by the sensing diaphragm 112 is obtained, and then, a measurement result of the pressure from the pressure sensor 100 may be obtained.

In some examples, the groove structure 110a may be cylindrical, cylindroid or prismatic such as quadrangular. In some examples, the through hole structure 110b may be cylindrical through holes. In some examples, the boss structure 110c may be cylindrical, cylindroid or prismatic such as quadrangular. In addition, in some examples, the groove structure 110a, the through hole structure 110b and the boss structure 110c may be coaxial.

In some examples, in the sensing unit 110, the through hole structure 110b may be perpendicular to the surface, close to the groove structure 110a of the sensing diaphragm 112. In such a case, the optical component 120 may be collimated by the through hole structure 110b perpendicular to the sensing diaphragm 112, thereby it is facilitated that the first light guide surface and the second light guide surface of the pressure sensor 100 are parallel.

In some examples, the optical component 120 may include a fiber-optic 121 and a sleeve 122 having a hollow part and sleeving the periphery of the fiber-optic 121, and the sleeve 122 may be used for connecting the fiber-optic 121 to the sensing unit 110 (with reference to FIG. 1A). Specifically, the through hole structure 110b may have an internal diameter matching the external diameter of the sleeve 122, and the sleeve 122 may have an internal diameter matched with the external diameter of the fiber-optic 121. The fiber-optic 121 may be placed into the sleeve 122 and may be fixed to the sleeve 122 in a manner such as laser welding, and then, the sleeve 122 may be placed into the through hole structure 110b and may be fixed to the boss structure 110c in a manner such as laser welding (with reference to FIG. 1A). In such a case, the fiber-optic 121 is connected to the sensing unit 110 by using the sleeve 122, thereby the fiber-optic 121 may be collimated, it is facilitated that the first light guide surface and the second light guide surface of the pressure sensor 100 are parallel. In some examples, the sleeve 122 may be a glass tube.

In an embodiment as shown in FIG. 1A and FIG. 1B, the size of the sleeve 122 may match the size of the through hole structure 110b, and the sleeve 122 may be embedded in the through hole structure 110b. The size of the fiber-optic 121 may match the size of the hollow part of the sleeve 122, and the fiber-optic 121 may be embedded in the hollow part of the sleeve 122. The axis of the hollow part of the sleeve 122 may be orthogonal to the first light guide surface, and the end surface of the end, embedded in the hollow part, of the fiber-optic 121 may be parallel to the first light guide surface.

In other words, the present disclosure may provide a pressure sensor 100. The pressure sensor 100 may include a sensing unit 110, a sleeve 122 having a hollow part (unshown) and a fiber-optic 121. The sensing unit 110 may include a first inner surface (namely the surface, close to a groove structure 110a, of a sensing diaphragm 112), a second inner surface opposite to the first inner surface, a cavity formed between the first inner surface and the second inner surface and a through hole 110b communicating with the cavity via the second inner surface. The size of the sleeve 122 may match the size of the through hole structure 110b, and the sleeve 122 may be embedded in the through hole structure 110b. The size of the fiber-optic 121 may match the size of the hollow part of the sleeve 122, and the fiber-optic 121 may be embedded in the hollow part of the sleeve 122. The axis of the hollow part may be orthogonal to the first light guide surface, and the end surface of the end, embedded in the hollow part of the fiber-optic 121 may be parallel to the first light guide surface. A light ray entering the cavity via the fiber-optic 121 may be reflected between the end surface of the end, embedded in the hollow part, of the fiber-optic 121 and the first inner surface. In such a case, the consistency of a plurality of fiber-optic Fabry-Perot pressure sensors 100 may be improved by improving the consistency of a plurality of sensing units 110.

In some examples, the sleeve 122 may be combined with the sensing unit 110 by laser welding. In addition, in some examples, the fiber-optic 121 may be combined with the sleeve 122 by laser welding.

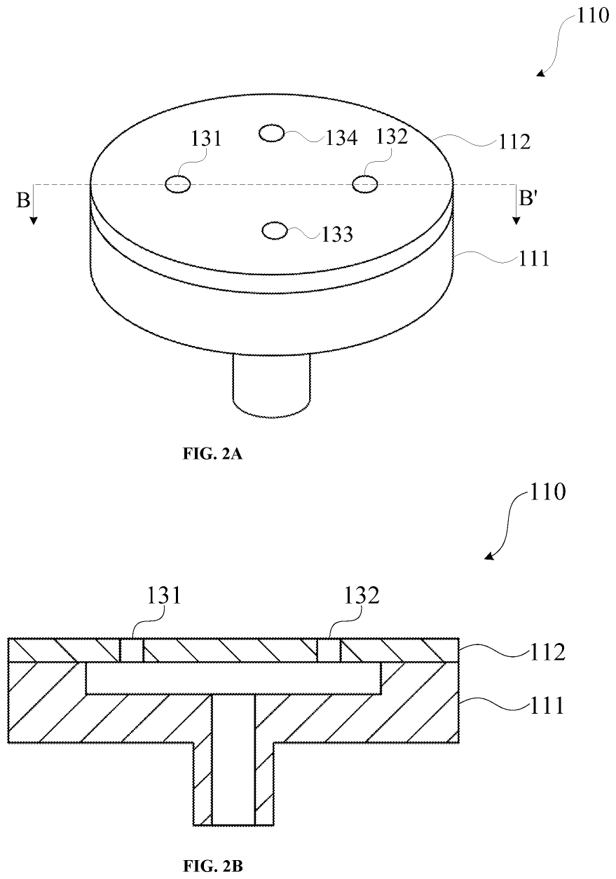

FIG. 2A schematically shows a stereoscopic view of a nonrestrictive example of the sensing unit 110 according to various embodiments of the present disclosure; and FIG. 2B shows a sectional view of the sensing unit 110 in FIG. 2A along a direction BB′.

In some examples, a plurality of air holes communicating with the groove structure 110a may be fabricated in the sensing diaphragm 112 of the sensing unit 110 (with reference to FIG. 2A and FIG. 2B). In such a case, air pressures inside and outside the cavity of the sensing unit 110 may be balanced by communicating the plurality of air holes with the groove structure 110a, then, influences caused by imbalance of the air pressures at two sides of the diaphragm in a deformation process of the sensing diaphragm 112 may be reduced, and the accuracy of pressure measurement may be further improved.

In some examples, the number of the plurality of air holes may be 2 to 12, for example, the number of the air holes may be 2, 3, 4, 5, 6, 8, 9, 10 or 12. In an embodiment as shown in FIG. 2A and FIG. 2B, the plurality of air holes may include a first air hole 131, a second air hole 132, a third air hole 133 and a fourth air hole 134 (with reference to FIG. 2A). In some examples, the first air hole 131, the second air hole 132, the third air hole 133 and the fourth air hole 134 may be uniformly distributed around the axis of the through hole structure 110b. Therefore, the air pressures at two sides of the sensing diaphragm 112 may be more effectively balanced.

In some examples, the plurality of air holes may penetrate from the upper surface (namely the surface, away from the groove structure 110a, of the sensing diaphragm 112) of the sensing diaphragm 112 to the lower surface (namely the surface, close to the groove structure 110a, of the sensing diaphragm 112) of the sensing diaphragm 112. In other words, axes of the plurality of air holes may be orthogonal to the sensing diaphragm 112 or form a predetermined included angle with the sensing diaphragm 112 (with reference to FIG. 2A and FIG. 2B).

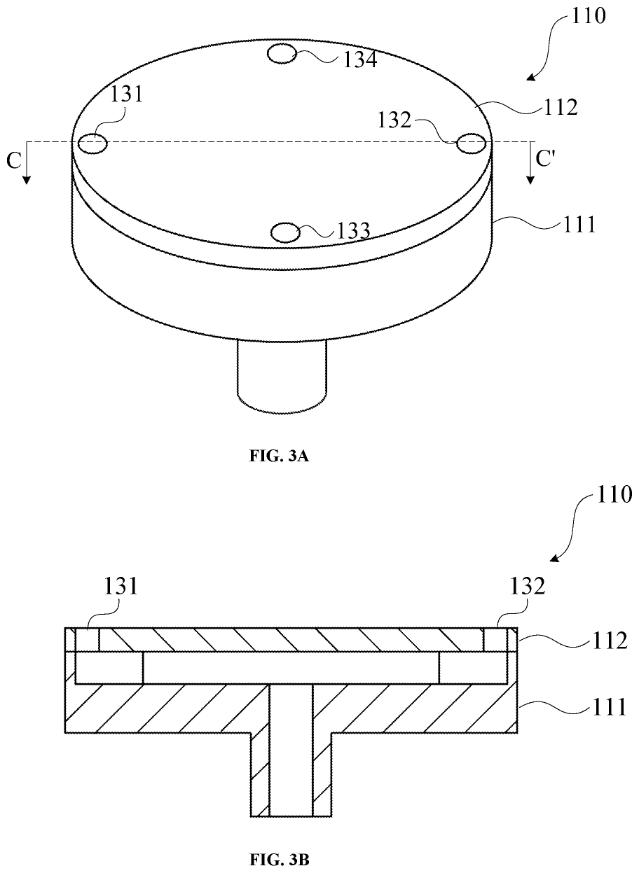

FIG. 3A schematically shows a stereoscopic view of another nonrestrictive example of the sensing unit 110 according to various embodiments of the present disclosure; and FIG. 3B shows a sectional view of the sensing unit 110 in FIG. 3A along a direction CC′.

In some other examples, the plurality of air holes may be further formed in such a manner: the edge of the sensing diaphragm 112 is connected to the lower surface of the sensing diaphragm 112, a ditch-shaped groove communicating with the plurality of air holes of the sensing diaphragm 112 is formed in the side, close to the sensing diaphragm 112, of the base 111, and thus, L-shaped air holes communicating to the groove structure 110a are formed as a whole (with reference to FIG. 3B). In other words, in an embodiment as shown in FIG. 3A and FIG. 3B, the air holes 131 may include the holes formed in the sensing diaphragm 112 and the ditch-shaped grooves formed in the base 111 and communicating with the groove structure 110a, and the holes formed in the sensing diaphragm 112 communicate with the grooves formed in the base 111, so that the outside communicates with the groove structure 110 via the air holes 131.

As mentioned above, in the pressure sensor 100, the distance between the two light guide surfaces in the Fabry-Perot cavity may be changed due to deformation generated by pressure sensing performed by the sensing diaphragm 112, and the distance between the two light guide surfaces may be obtained by the optical feedback generated when the light ray is reflected between the two light guide surfaces. Therefore, the deformation generated by the sensing diaphragm 112 due to the pressure may be obtained, and thus, the measurement result of the pressure may be obtained.

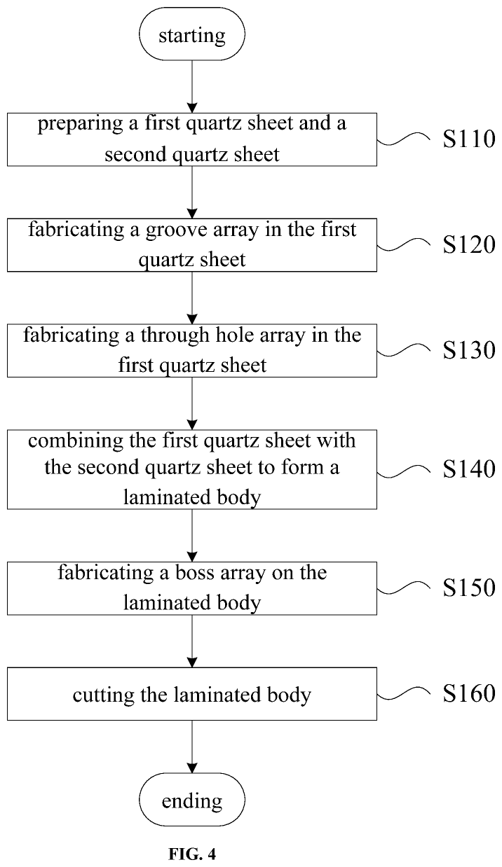

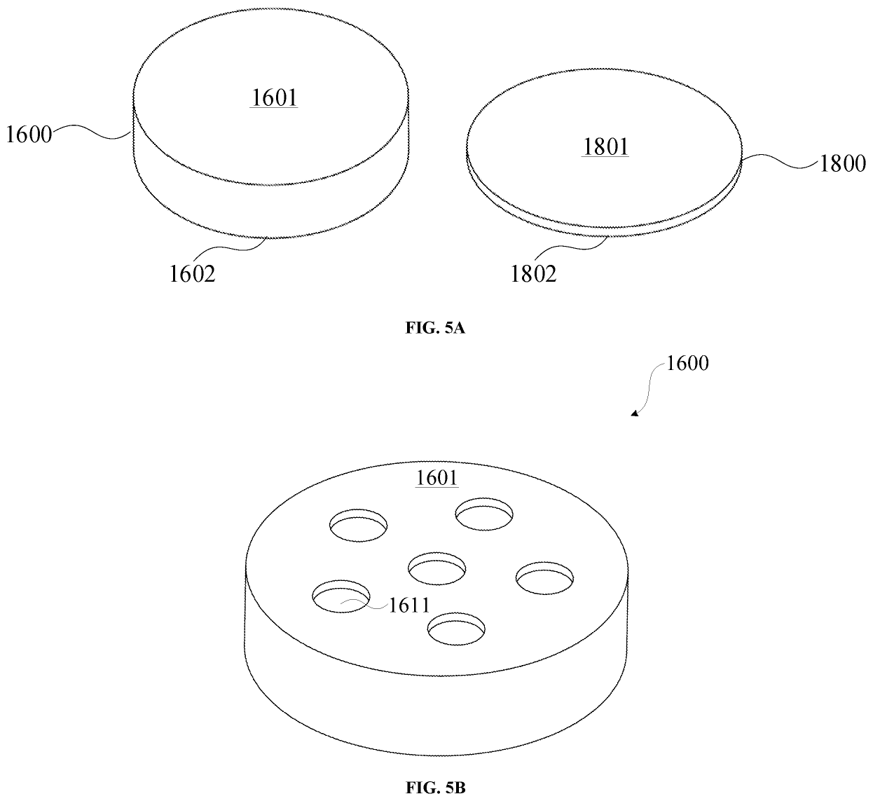

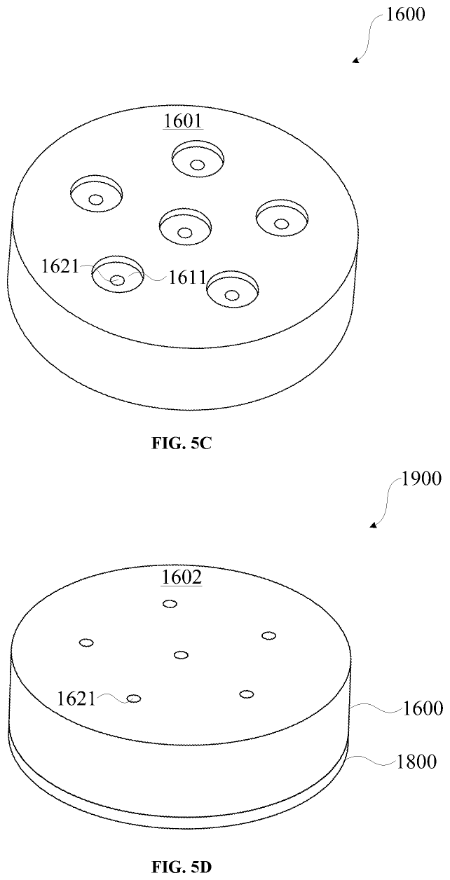

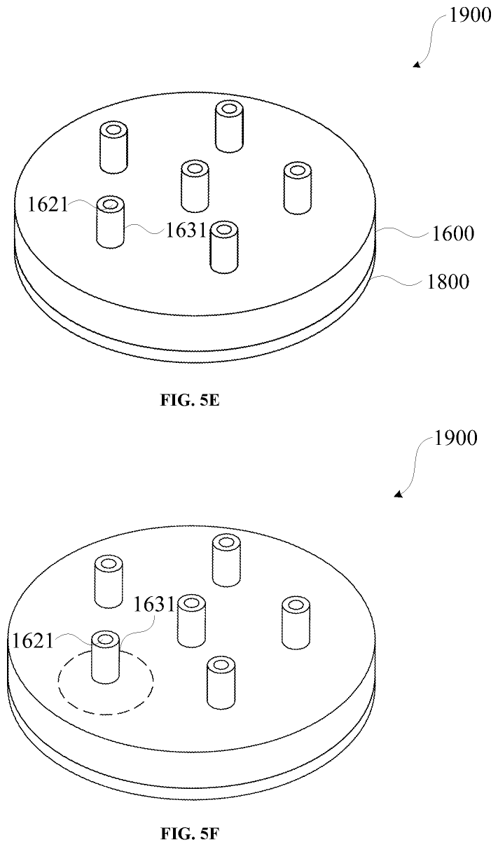

It may be thus seen that, in the pressure sensor 100, the improvement on the consistency of the sensing units 110 in the pressure sensors 100 may facilitate the improvement on the consistency of the pressure sensors 100. As below, a batch preparation method capable of improving the consistency of the sensing units 110 will be described with reference to FIG. 4 and FIG. 5A to FIG. 5F.

FIG. 4 schematically shows a process view of a nonrestrictive example of a batch preparation method according to various embodiments of the present disclosure. FIG. 5A schematically shows a stereoscopic view of a nonrestrictive example of a first quartz sheet 1600 and a second quartz sheet 1800 according to various embodiments of the present disclosure.

In the present embodiment, as shown in FIG. 4, the preparation method may include the following steps: preparing a first quartz sheet 1600 and a second quartz sheet 1800 (step S110); fabricating a groove array in the first quartz sheet 1600 (step S120); fabricating a through hole array in the first quartz sheet 1600 (step S130); combining the first quartz sheet 1600 with the second quartz sheet 1800 to form a laminated body 1900 (step S140); fabricating a boss array on the laminated body 1900 (step S150); and cutting the laminated body 1900 (step S160).

In the step S110 of the present embodiment, the first quartz sheet 1600 with an upper surface 1601 and a lower surface 1602 which are opposite and the second quartz sheet 1800 with an upper surface 1801 and a lower surface 1802 which are opposite are prepared (with reference to FIG. 5A). It should be understood that the terms such as “upper surface” and “lower surface” may be used for distinguishing different parts, but should not be regarded to be restrictive.

In some examples, the upper surface 1601 of the first quartz sheet 1600 may be polished. In some examples, the upper surface 1801 of the second quartz sheet 1800 may be polished. In such a case, the upper surface 1601 of the first quartz sheet 1600 and the upper surface 1801 of the second quartz sheet 1800 are polished, which may facilitate the combination between the upper surface 1601 of the first quartz sheet 1600 and the upper surface 1801 of the second quartz sheet 1800, and thus, the tightly combined laminated body 1900 may be formed.

In some examples, the lower surface 1602 of the first quartz sheet 1600 may be polished. In some examples, the lower surface 1802 of the second quartz sheet 1800 may be roughened. Therefore, influences of the lower surface 1802 of the second quartz sheet 1800 on light reflection may be reduced.

In some examples, the thickness of the first quartz sheet 1600 may be bigger than the thickness of the second quartz sheet 1800. In some examples, the first quartz sheet 1600 and the second quartz sheet 1800 may be circular quartz sheets (with reference to FIG. 5A). In some examples, the first quartz sheet 1600 or the second quartz sheet 1800 may be a 2-inch wafer, a 4-inch wafer or a 6-inch wafer. In some examples, the diameter of the first quartz sheet 1600 may be equal to the diameter of the second quartz sheet 1800. In some examples, the diameter of the first quartz sheet 1600 may be slightly smaller than the diameter of the second quartz sheet 1800. Therefore, the upper surface 1801 of the second quartz sheet 1800 may cover the upper surface 1601 of the first quartz sheet 1600.

In some other examples, the thickness of the first quartz sheet 1600 may be further equal to or smaller than the thickness of the second quartz sheet 1800.

In some examples, the first quartz sheet 1600 may be a circular quartz sheet which is consistent in thickness. In some examples, the thickness of the first quartz sheet 1600 may range from 1 mm to 2 mm. In some examples, the second quartz sheet 1800 may be a circular quartz sheet which is consistent in thickness. In some examples, the thickness of the second quartz sheet 1800 may range from 10 μm to 500 μm.

FIG. 5B schematically shows that grooves 1611 are fabricated in the first quartz sheet 1600 according to various embodiments of the present disclosure.

As mentioned above, in the step S210 of the present embodiment, the groove array including a plurality of grooves may be fabricated in the upper surface 1601 of the first quartz sheet 1600. It needs to be noted that, in an embodiment as shown in FIG. 5B, for labeling convenience consideration, one of the plurality of grooves is marked, and the marked groove is numbered as 1611. In some examples, the plurality of grooves may be uniformly distributed in the upper surface 1601 of the first quartz sheet 1600 (with reference to FIG. 5B).

In some examples, all the grooves may be cylindrical, cylindroid or prismatic. In some examples, optionally, each of all the grooves may be cylindrical. In some examples, each of all the grooves may have the same diameter. In some other examples, each of all the grooves may have different diameter. In some examples, each of all the grooves may have the same depth.

In some examples, the diameter of each of all the grooves may range from 80 μm to 10 mm. In some examples, the depths of each of all the grooves may range from 3 μm to 1000 μm.

In some examples, the axle distance between the adjacent grooves may be 1.5 to 2 times as the diameter of each of the grooves. However, the examples in the present implementation are not limited to this. In other examples, the axle distance between the adjacent grooves may be 2 to 4 times as the diameter of each of the grooves.

In some examples, each of all the grooves may be fabricated in the upper surface 1601 of the first quartz sheet 1600 by micromachining. For example, a plurality of grooves having the same diameter and the same depth may be fabricated in the upper surface 1601 of the first quartz sheet 1600 by computer numerical control machining (CNC machining).

FIG. 5C schematically shows that through holes 1621 are fabricated in the first quartz sheet 1600 according to various embodiments of the present disclosure.

As mentioned above, in the step S130 of the present embodiment, the through hole array including the plurality of through holes may be fabricated in the lower surface 1602 of the first quartz sheet 1600 (with reference to FIG. 5C). Specifically, a plurality of through holes may be fabricated in positions corresponding to all the grooves in the lower surface 1602 of the first quartz sheet 1600. It needs to be noted that, in an embodiment as shown in FIG. 5C, for labeling convenience consideration, one of the plurality of through holes is marked, and the marked through hole is numbered as 1621. In some examples, the plurality of through holes may be uniformly distributed in the first quartz sheet 1600 (with reference to FIG. 5C).

In some examples, all the through holes may be cylindrical through holes or prismatic through holes. In some examples, each of all the through holes may be coaxial with each of all the grooves respectively. For example, the through hole 1621 may be coaxial with a groove 1611.

In some examples, each of all the through holes may have the same aperture. In some examples, the aperture of each of all the through holes may be smaller than the diameter of each of all the grooves respectively. For example, the aperture of the through hole 1621 may be smaller than the diameter of the groove 1611. In some examples, the aperture of each of all the through holes may range from 50 μm to 2.4 mm.

In some examples, a plurality of through holes may be fabricated in the lower surface 1602 of the first quartz sheet 1600 by micromachining. For example, a plurality of through holes having the same apertures may be fabricated in the lower surface 1602 of the first quartz sheet 1600 by computer numerical control machining (CNC machining).

FIG. 5D schematically shows a nonrestrictive example of a laminated body 1900 according to various embodiments of the present disclosure.

As mentioned above, in the step S140 of the present embodiment, the upper surface 1801 of the second quartz sheet 1800 is combined with the upper surface 1601 of the first quartz sheet 1600 in a manner of covering the plurality of grooves to form the laminated body 1900 (with reference to FIG. 5D).

In some examples, the first quartz sheet 1600 and the second quartz sheet 1800 may be combined by thermal bonding. In some examples, the first quartz sheet 1600 and the second quartz sheet 1800 may be combined by high-temperature thermal compression bonding or low-temperature bonding. In some other examples, the first quartz sheet 1600 and the second quartz sheet 1800 may be combined by an adhesive.

In some examples, the first quartz sheet 1600 and the second quartz sheet 1800 may be bonded as the following steps: cleaning the upper surface 1601 of the first quartz sheet 1600 and the upper surface 1801 of the second quartz sheet 1800; thermal compressively prebonding the first quartz sheet 1600 and the second quartz sheet 1800 in a low-temperature environment; and t high-temperature thermal compressively connecting the first quartz sheet 1600 and the second quartz sheet 1800 in a high-temperature environment.

In some examples, the cleaning may be RCA standard cleaning or megasonic cleaning and the like. In some examples, the temperature of the low-temperature environment may be 200° C. to 500° C. In some examples, an air pressure for the thermal compression prebonding may be 1 Bar to 50 Bar. In some examples, the processing time of the thermal compression prebonding may be 5 to 100 min. In some examples, the temperature of the high-temperature environment may be 900° C. to 1200° C. In some examples, the processing time of high-temperature annealing for consolidation may be 1 hour to 4 hours.

In some examples, in the laminated body 1900, axe of each of all the grooves may be perpendicular to the upper surface 1801 of the second quartz sheet 1800, and axe of each of all the through holes may be perpendicular to the upper surface 1801 of the second quartz sheet 1800.

FIG. 5E schematically shows that bosses 1631 are fabricated on the laminated body 1900 according to various embodiments of the present disclosure.

As mentioned above, in the step S150 of the present embodiment, the boss array including a plurality of bosses may be fabricated on the laminated body 1900. Specifically, the plurality of bosses may be fabricated on positions corresponding to all the through holes in the lower surface 1602 of the first quartz sheet 1600 of the laminated body 1900. It needs to be noted that, in an embodiment as shown in FIG. 5E, for labeling convenience consideration, one of the plurality of bosses is marked, and the marked boss is numbered as 1631. In some examples, the plurality of bosses may be uniformly distributed on the first quartz sheet 1600 (with reference to FIG. 5E).

In some examples, all the bosses may be cylindrical bosses or prismatic bosses. In some examples, each of all the bosses may be coaxial with all the through holes respectively. In some examples, each of all the bosses may have the same height. In some examples, the height of each of all the bosses may range from 0.5 mm to 1.5 mm. In some examples, each of all the bosses may have the same diameter. In some examples, the diameter of each of all the bosses may be smaller than the diameter of each of all the grooves respectively. In some examples, the diameter of each of all the bosses may range from 100 μm to 2.5 mm.

In some examples, in the laminated body 1900, the plurality of grooves and the plurality of bosses are respectively disposed on the side where the upper surface 1601 of the first quartz sheet 1600 is located and the side where the lower surface 1602 of the first quartz sheet 1600 is located, and each of all the through holes penetrate through each of all the bosses and communicate with each of the grooves respectively. For example, the groove 1611, the through hole 1621 and the boss 1631 may be coaxial, and the through hole 1621 may penetrate through the boss 1631 and communicate with the groove 1611.

In some examples, each of all the bosses may be fabricated in the lower surface 1602 of the first quartz sheet 1600 by micromachining. For example, a plurality of bosses having the same height and diameter may be fabricated on the lower surface 1602 of the first quartz sheet 1600 by computer numerical control machining (CNC machining). In some examples, the said each of all the bosses may facilitate the welding of the optical component 120 on the sensing unit 110.

FIG. 5F schematically shows that the laminated body 1900 is cut according to various embodiments of the present disclosure.

As mentioned above, in the step S160 of the present embodiment, the laminated body 1900 is cut to obtain a plurality of sensing units. Specifically, as shown in FIG. 5F, with the through hole 1621 and the boss 1631 as examples, the laminated body 1900 is cut columnarly such as cylindrically or prismatically with a predetermined diameter along a dotted line as shown in the figure and is cut to the lower surface 1802 of the second quartz sheet 1800 along the axis direction of the through hole 1621. Other through holes and other bosses are cut and processed in the same or similar manner to obtain the plurality of sensing units. In some examples, the above-mentioned predetermined diameter may be greater than the diameter of each of the grooves and is not greater than the axle distance between the adjacent through holes.

In addition, in some examples, the process for fabricating the plurality of air holes may be disposed between the step S130 and the step S140. For example, the upper surface (and/or the lower surface) of the first quartz sheet 1600 may be the same as the upper surface (and/or the lower surface) of the second quartz sheet 1800, the plurality of grooves and the plurality of through holes are fabricated in a first predetermined position of the first quartz sheet 1600, the plurality of air holes are respectively fabricated in a corresponding second predetermined position on the second quartz sheet 1800, and the first quartz sheet 1600 is combined with the second quartz sheet 1800 in a manner that the first predetermined position corresponds to the second predetermined position. In some examples, positioning holes (unshown) may be respectively disposed in the first quartz sheet 1600 and the second quartz sheet 1800, and the first predetermined position may align to the second predetermined position by means of the positioning holes.

In some other examples, the process for fabricating the plurality of air holes may be disposed between the step S140 and the step S160. For example, the plurality of air holes are respectively fabricated in positions corresponding to all the grooves on the second quartz sheet 1800 of the laminated body 1900.

In some other examples, the process for fabricating the plurality of air holes may be disposed after the step S160 is completed. For example, after the laminated body 1900 is cut, the plurality of air holes communicating with the groove structure 110a are fabricated in the sensing diaphragm 112.

In the present embodiment, the plurality of grooves having the same diameter and depth are fabricated in the first quartz sheet 1600, and the plurality of grooves are covered by the second quartz sheet 1800, so that a plurality of cavities which are higher in consistency (such as consistent shape, consistent size and the like) may be formed. In addition, the thicknesses of the second quartz sheets 1800 are consistent, and thus, a plurality of sensing diaphragms which may respectively match all the cavities and may be higher in consistency (such as consistent material, consistent shape and consistent size, thereby obtaining consistent deformation generated by inducing a pressure) may be formed. In such a case, by cutting the laminated body 1900 formed by combination of the first quartz sheet 1600 and the second quartz sheet 1800, the plurality of sensing units 110 which are higher in consistency may be obtained.

According to the batch preparation method in the present embodiment, the consistency of the sensing units 110 may be improved, and thus, the consistency of the pressure sensors 100 may be improved.

Various embodiments of the present disclosure further relate to another pressure sensor. Various embodiments of the present disclosure further relate to a batch preparation method for a sensing unit of a fiber-optic Fabry-Perot pressure sensor. By using the high-consistency preparation method in the present embodiment, the consistency of sensing units of pressure sensors may be improved, and thus, the consistency of the pressure sensors may be improved.

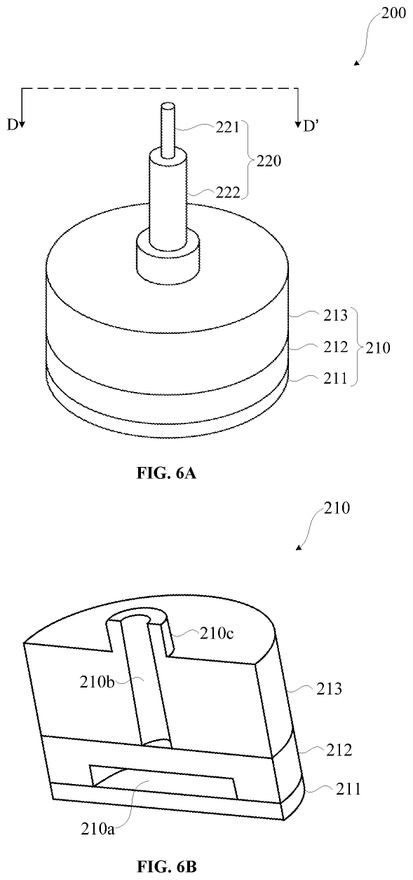

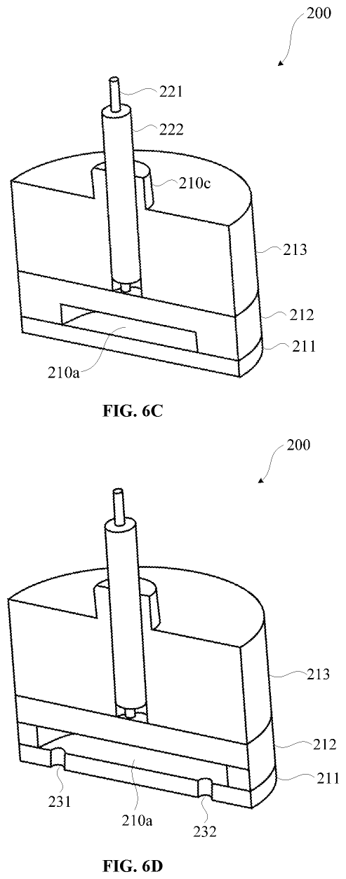

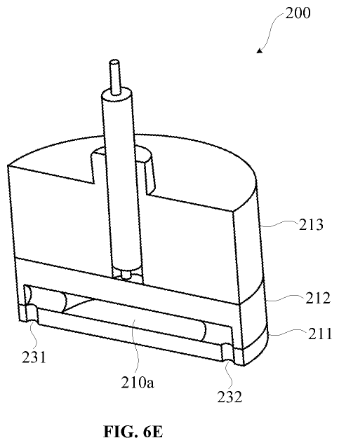

FIG. 6A schematically shows a stereoscopic view of another nonrestrictive example of a pressure sensor 200 according to various embodiments of the present disclosure; FIG. 6B shows a sectional view of a sensing unit 210 in FIG. 6A along a direction DD′; and FIG. 6C shows a sectional view of the pressure sensor 200 in FIG. 6A along the direction DD′.

In the present embodiment, the pressure sensor 200 may include a sensing unit 210 and an optical component 220 connecting to the sensing unit 210 (with reference to FIG. 6A). A pressure may be sensed by the sensing unit 210, and a sensing signal of the pressure may be obtained by matching the optical component 220 with the sensing unit 210. In some examples, the optical component 220 may connect to a demodulation device (unshown) for demodulating the sensing signal and may transmit the sensing signal to the demodulation device, and the demodulation device may demodulate the sensing signal, thereby obtaining a measurement result of the pressure.

In some examples, the sensing unit 210 may include a first diaphragm 211, a second diaphragm 212 and a third diaphragm 213 which are sequentially laminated (with reference to FIG. 6A). In some examples, a cavity 210a (with reference to FIG. 6B) may be formed between the first diaphragm 211 and the second diaphragm 212. In addition, the third diaphragm 213 may have a through hole 210b (with reference to FIG. 6B) communicating with the cavity 210a. In addition, the third diaphragm 213 may further have a boss 210c (with reference to FIG. 6B) which may be penetrated by the through hole 210b.

In addition, in some examples, the surface of the first diaphragm 211 which is close to the cavity 210a may be polished, the upper surface and the lower surface of the second diaphragm 212 may be polished, and the surface of the third diaphragm 213 which is close to the cavity 210a may be polished.

In some examples, the optical component 220 may include a fiber-optic 221 (with reference to FIG. 6A). In some examples, the optical component 220 may further include a glass tube 222 with a hollow part, and the fiber-optic 221 may be embedded in the hollow part of the glass tube 222 (with reference to FIG. 6C).

In some examples, one end of the fiber-optic 221 may be cut to be flat, and the end may be placed into the through hole 210b (with reference to FIG. 6C). In such a case, the surface, close to the cavity 210a, of the first diaphragm 211 may be used as a first light guide surface, the surface of the second diaphragm 212 which is close to the cavity 210a may be used as a second light guide surface, the cavity 210a, the first light guide surface and the second light guide surface may form a Fabry-Perot cavity.

When the pressure sensor 200 related to the present embodiment is used to measure a pressure, the first diaphragm 211 may deform due to the pressure to change the distance between the first light guide surface (i.e. the surface of the first diaphragm 211 which is close to the cavity 210a) and the second light guide surface (i.e. the surface of the second diaphragm 212 which is close to the cavity 210a), and thus, optical feedback generated when a ray is reflected between the first light guide surface and the second light guide surface may be changed. The demodulation device may obtain the distance between the first light guide surface and the second light guide surface based on the changed optical feedback, so that the deformation generated by the sensing diaphragm 211 is obtained, and then, a measurement result of the pressure from the pressure sensor 200 may be obtained.

In some examples, the cavity 210a may be cylindrical, cylindroid or prismatic such as quadrangular. In some examples, the through hole 210b may be a cylindrical through hole. In some examples, the boss 210c may be cylindrical, cylindroid or prismatic such as quadrangular. In addition, in some examples, the cavity 210a, the through hole 210b and the boss 210c may be coaxial.

In some examples, in the sensing unit 210, the through hole 210b may be perpendicular to the surface of the second diaphragm 212 which is close to the cavity 210a. Therefore, the fiber-optic 221 is collimated by the through hole 210b, thereby facilitating that an incident light beam emitted from the fiber-optic 221 is coupled to enter the pressure sensor 200 and is reflected between the first light guide surface and the second light guide surface and a light beam reflected from the first light guide surface and the second light guide surface of the pressure sensor 200 is coupled to enter the fiber-optic 221.

In some examples, the through hole 210b may have an internal diameter matching the external diameter of the glass tube 222, and the glass tube 222 may have an internal diameter matching the external diameter of the fiber-optic 221. The fiber-optic 221 may be placed into the glass tube 222 and may be fixed into the glass tube 222 in a manner such as high-temperature welding, then, the glass tube 222 may be placed into the through hole 210b, and the end surface of the fiber-optic 221 which is cut to be flat is fitted to the surface of the second diaphragm 212 which is away from the cavity 210a, and the glass tube 222 is fixed to the boss 210c in a manner such as high-temperature welding (with reference to FIG. 6C). In such a case, the fiber-optic 221 is connected to the sensing unit 210 by using the glass tube 222, by which the fiber-optic 221 may be collimated, thereby facilitating that the incident light beam emitted from the fiber-optic 221 is coupled to enter the pressure sensor 200 and is reflected between the first light guide surface and the second light guide surface and the light beam reflected from the first light guide surface and the second light guide surface of the pressure sensor 200 is coupled to enter the fiber-optic 221.

In some examples, the end surface of the end of the fiber-optic 221 which is cut to be flat may be further provided with a collimating element (unshown). The collimating element may collimate light emitted from the fiber-optic 221. In some example, the end of the fiber-optic 221 which is cut to be flat may be embedded in the hollow part of the glass tube 222 or the through hole 210b.

The present disclosure may provide a pressure sensor 200. The pressure sensor 200 may include a sensing unit 210, a glass tube 222 having a hollow part and a fiber-optic 221. The sensing unit 210 may include a first inner surface (i.e. the surface of a first diaphragm 211 which is close to a cavity 210a), a second inner surface (i.e. the surface of the second diaphragm 212 which is close to the cavity 210a) opposite to the first inner surface, the cavity 210a formed between the first inner surface and the second inner surface and a third diaphragm 213 having a through hole 210b. The size of the glass tube 222 may match the size of the through hole 210b, and the glass tube 222 may be embedded in the through hole 210b. The size of the fiber-optic 221 may match the size of the hollow part of the glass tube 222, and the fiber-optic 221 may be embedded in the hollow part. The axis of the hollow part may be orthogonal to the second light guide surface, and the end surface of the end of the fiber-optic 221 which is embedded in the hollow part is fitted to the surface, away from the cavity 210a of the second diaphragm 212. A light ray entering the cavity via the fiber-optic 221 may be reflected between the first light guide surface and the second light guide surface.

In some examples, the glass tube 222 may be combined with the sensing unit 210 in a manner of high-temperature fusion welding such as laser welding. In addition, in some examples, the fiber-optic 221 may be combined with the glass tube 222 in a manner of high-temperature fusion welding such as laser welding.

FIG. 6D schematically shows a sectional view of a nonrestrictive example of the pressure sensor 200 according to various embodiments of the present disclosure; and FIG. 6E schematically shows a sectional view of another nonrestrictive example of the pressure sensor 200 according to various embodiments of the present disclosure.

In some examples, a plurality of air holes communicating with the cavity 210a may be fabricated in the first diaphragm 211 of the sensing unit 210 (with reference to FIG. 6D or FIG. 6E). In such a case, air pressures inside and outside the cavity 210a may be balanced by communicating the air holes with the cavity 210a, then, influences caused by imbalance of the air pressures at two sides of the diaphragm in a deformation process of the first diaphragm 211 may be reduced, and the pressure sensing accuracy may be further improved. In some examples, the pressure sensor 200 may be used for sensing a sound pressure. Therefore, a sensing unit 210 capable of sensing a sound pressure may be provided, and the accuracy of the sensing unit 210 sensing the sound pressure may be improved.

In some examples, the number of the air holes may be 2 to 12, for example, the number of the air holes may be 2, 3, 4, 5, 6, 8, 9, 10, or 12. In an embodiment as shown in FIG. 6D and FIG. 6E, the plurality of air holes may include a first air hole 231 and a second air hole 232. In some examples, the plurality of air holes may be uniformly distributed around the axis of the through hole 210b. Therefore, the air pressures inside and outside the cavity 210a may be more effectively balanced.

In some examples, the plurality of air holes may penetrate through the first diaphragm 211. In some examples, axes of the plurality of air holes may be orthogonal to the first diaphragm 211 or form a predetermined included angle with the first diaphragm 211. In some examples, the axis of the through hole 210b may not pass by any one of the plurality of air holes.

In some other examples, the air holes (such as the air hole 231 and the air hole 232 in FIG. 6E) may be further formed in such a manner: a first part of the air hole 231 is a hole penetrating from the edge of the first diaphragm 211 to a first optical surface of the first diaphragm 211, a second part of the air hole 231 is a ditch-shaped groove formed on the side of the second diaphragm 212 which is close to the cavity 210a, and communicating with the cavity 210a, the first part and the second part of the air hole 231 communicate, and thus, L-shaped air holes communicating to the cavity 210a are formed as a whole (with reference to FIG. 6E).

In other words, in an embodiment as shown in FIG. 6E, the air hole 231 (with the air hole 231 as an example) may include the hole formed in the first diaphragm 211 and the groove formed in the second diaphragm 212 and communicating with the cavity 210a. When the first diaphragm 211 is combined with the second diaphragm 212, the hole formed in the first diaphragm 211 is enabled to align to the groove formed in the second diaphragm 212 so as to communicate with the groove, so that the outside communicates with the cavity 210 via the air hole 231.

As mentioned above, in the pressure sensor 200, the distance between the two light guide surfaces in the Fabry-Perot cavity may be changed due to deformation generated by pressure sensing performed by the first diaphragm 211, and the distance between the two light guide surfaces may be obtained by the optical feedback generated when the light ray is reflected between the two light guide surfaces. Therefore, the deformation generated by the first diaphragm 211 due to the pressure may be obtained, and thus, the measurement result of the pressure may be obtained.

It may be thus seen that, in the pressure sensor 200, the improvement on the consistency of the sensing units 210 in the pressure sensors 200 facilitates the improvement on the consistency of the pressure sensors 200.

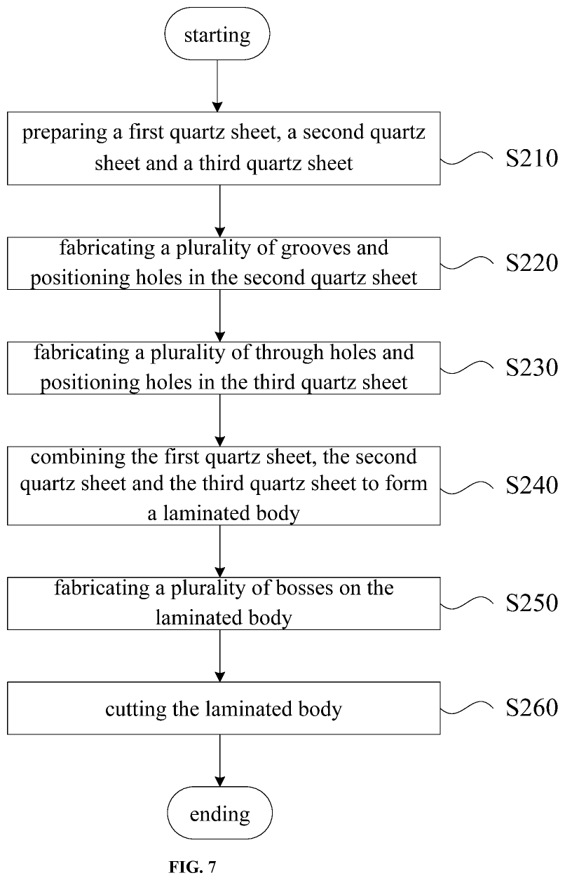

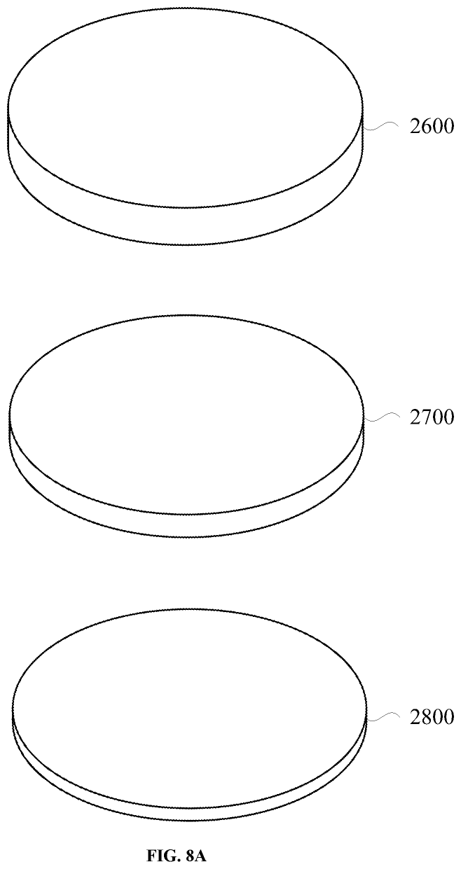

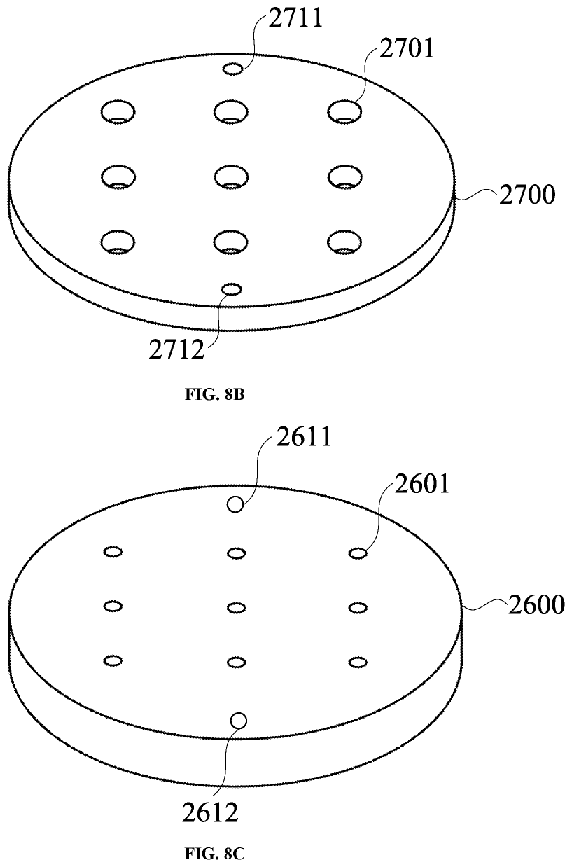

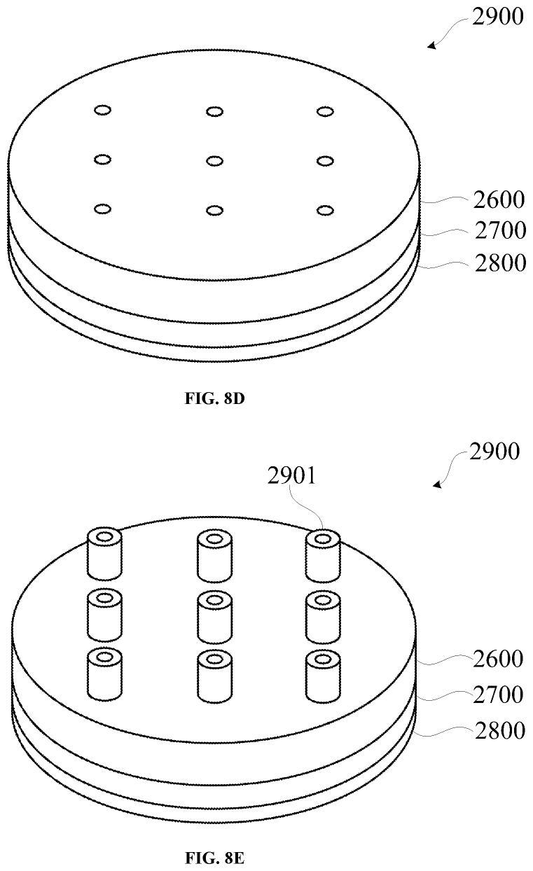

FIG. 7 schematically shows a flow chart of a nonrestrictive example of a high-consistency preparation method according to various embodiments of the present disclosure. FIG. 8A schematically shows a stereoscopic view of a nonrestrictive example of a first quartz sheet, a second quartz sheet, and a third quartz sheet according to various embodiments of the present disclosure.

In the present embodiment, as shown in FIG. 7, the high-consistency preparation method may include the following steps: preparing a first quartz sheet 2600, a second quartz sheet 2700 and a third quartz sheet 2800 (step S210); fabricating a plurality of grooves 2701 and positioning holes (a positioning hole 2711 and a positioning hole 2712) in the second quartz sheet 2700 (step S220); fabricating a plurality of through holes 2601 and positioning holes (a positioning hole 2611 and a positioning hole 2612) in the first quartz sheet 2600 (step S230); the first quartz sheet 2600, combining the second quartz sheet 2700 and the third quartz sheet 2800 to form a laminated body 2900 (step S240); fabricating a plurality of bosses 2901 on the laminated body 2900 (step S250); and cutting the laminated body 2900 (step S260).

In the step S210 in the present embodiment, the first quartz sheet 2600 with an upper surface and a lower surface which are opposite, the second quartz sheet 2700 with an upper surface and a lower surface which are opposite and the third quartz sheet 2800 with an upper surface and a lower surface which are opposite are prepared (with reference to FIG. 8A). It should be understood that terms such as “upper surface” and “lower surface” may be used for distinguishing different parts, but should not be regarded to be restrictive.

In some examples, the lower surface of the first quartz sheet 2600 may be polished. In some examples, the upper surface and the lower surface of the second quartz sheet 2700 may be polished, and the upper surface of the third quartz sheet 2800 may be polished. In such a case, the lower surface of the first quartz sheet 2600 and the upper surface of the second quartz sheet 2700 are polished, which facilitates the combination between the lower surface of the first quartz sheet 2600 and the upper surface of the second quartz sheet 2700, and the lower surface of the second quartz sheet 2700 and the upper surface of the third quartz sheet 2800 are polished, which facilitates the combination between the lower surface of the second quartz sheet 2700 and the upper surface of the third quartz sheet 2800, and thus, the tightly combined laminated body 2900 may be formed.

In some examples, the lower surface of the third quartz sheet 2800 may be roughened. Therefore, influences of the lower surface of the third quartz sheet 2800 on light reflection may be reduced.

In some examples, the thickness of the second quartz sheet 2700 may be smaller than the thickness of the first quartz sheet 2600, and the thickness of the third quartz sheet 2800 may be smaller than the thickness of the second quartz sheet 2700. In some examples, the first quartz sheet 2600, the second quartz sheet 2700 and the third quartz sheet 2800 may be cylindrical quartz sheets (with reference to FIG. 8A). In some examples, the first quartz sheet 2600 or the second quartz sheet 2700 or the third quartz sheet 2800 may be a 2-inch wafer, a 4-inch wafer or a 6-inch wafer. In some examples, the diameter of the second quartz sheet 2700 may be equal to the diameter of the third quartz sheet 2800. In some examples, the diameter of the second quartz sheet 2700 may be slightly smaller than the diameter of the third quartz sheet 2800. Therefore, the upper surface of the third quartz sheet 2800 may cover the lower surface of the second quartz sheet 2700.

In some examples, the second quartz sheet 2700 may be a circular quartz sheet of equal thickness. In some examples, the thickness of the second quartz sheet 2700 may range from 0.1 mm to 2 mm. In some examples, the third quartz sheet 2800 may be a circular quartz sheet of equal thickness. In some examples, the thickness of the third quartz sheet 2800 may range from 10 μm to 500 μm. In some examples, the first quartz sheet 2600 may be a circular quartz sheet of equal thickness, and the thickness of the first quartz sheet 2600 may range from 0.5 mm to 2 mm.

FIG. 8B schematically shows that grooves are fabricated in the second quartz sheet 2700 according to various embodiments of the present disclosure.

As mentioned above, in the step S220 of the present embodiment, the plurality of grooves may be fabricated in the lower surface of the second quartz sheet 2700 (in an embodiment as shown in FIG. 8B, one of the plurality of grooves is marked as 2701). In the embodiment as shown in FIG. 8B, the plurality of grooves may be a groove array. In some examples, the grooves in the groove array may be uniformly distributed in the lower surface of the second quartz sheet 2700. In some examples, the groove array may be fabricated based on a predetermined distribution manner. An axle distance between the grooves is at least included in the predetermined distribution manner.

In some examples, the positions of the positioning hole 2711 and the positioning hole 2712 of the second quartz sheet 2700 may be close to the edge of the second quartz sheet 2700.

In some examples, the grooves in the groove array may be cylindrical, cylindroid or prismatic. In some examples, optionally, the grooves in the groove array may be cylindrical. In some examples, the grooves in the groove array may have the same diameter. In some other examples, the grooves in the groove array may have different diameters. In some examples, the grooves in the groove array may have the same depth.

In some examples, the diameters of the grooves in the groove array may range from 80 μm to 10 mm. In some examples, the depths of the grooves in the groove array may range from 3 μm to 100 μm.

In some examples, the axle distance between the adjacent grooves may be 1.5 to 2 times as large as the diameter of each of the grooves. However, examples in the present embodiment are not limited to this. In other examples, the axle distance between the adjacent grooves may be 2 to 4 times as large as the diameter of each of the grooves.

In some examples, the grooves in the groove array may be fabricated in batches in the lower surface of the second quartz sheet 2700 by using a MEMS process. By using the MEMS technology, the grooves in the groove array may have the approximately consistent depth, which facilitates the improvement on the consistency of the sensing units.

FIG. 8C schematically shows that through holes are fabricated in the first quartz sheet 2600 according to various embodiments of the present disclosure.

As mentioned above, in the step S230 of the present embodiment, the plurality of through holes (in an embodiment as shown in FIG. 8C, one of the plurality of through holes is marked as 2601) as well as a positioning hole 2611 and a positioning hole 2612 may be fabricated in the first quartz sheet 2600. Specifically, a plurality of through holes and positioning holes may be respectively fabricated in positions corresponding to all the grooves and the positioning holes of the second quartz sheet 2700, in the upper surface of the first quartz sheet 2600. In the embodiment as shown in FIG. 8C, the plurality of through holes may be a through hole array.

In some examples, the through holes in the through hole array may be cylindrical through holes or prismatic through holes. In some examples, the through hole array may be fabricated based on a predetermined distribution manner. In such a case, the groove array and the through hole array are fabricated based on the same predetermined distribution manner, and thus, it is facilitated to align all the grooves to all the through holes.

In some examples, the through holes in the through hole array may have the same aperture. In some examples, the apertures of each of all the through holes may be smaller than the diameters of each of all microcavities. For example, the aperture of the through hole in the through hole array may range from 50 μm to 2.4 mm.

In some examples, the positioning hole 2611 and the positioning hole 2612 of the first quartz sheet 2600 may be close to the edge of the first quartz sheet 2600.

In some examples, the through holes in the through hole array may be fabricated in the upper surface of the first quartz sheet 2600 by using a laser cutting process. For example, a plurality of through holes having the same aperture may be fabricated in the upper surface of the first quartz sheet 2600 by computer numerical control machining (CNC machining).

FIG. 8D schematically shows a nonrestrictive example of a laminated body 2900 according to various embodiments of the present disclosure.

As mentioned above, in the step S240 of the present embodiment, the upper surface of the third quartz sheet 2800 is combined with the upper surface of the second quartz sheet 2700 in a manner of covering the groove array, and the lower surface of the first quartz sheet 2600 is combined with the upper surface of the second quartz sheet 2700 under the condition that the positioning hole of the first quartz sheet 2600 aligns to the positioning hole of the second quartz sheet 2700, and thus, the laminated body 2900 is formed (with reference to FIG. 8D). In the laminated body 2900, the positioning hole of the second quartz sheet 2700 is coaxial with the positioning hole of the first quartz sheet 2600, and each of all the grooves in the groove array of the second quartz sheet 2700 are respectively coaxial with each of all the through holes in the through hole array of the first quartz sheet 2600. By alignment of the positioning hole of the second quartz sheet 2700 to the positioning hole of the first quartz sheet 2600, it is facilitated that all the grooves may be coaxial with all the through holes.

In some examples, the first quartz sheet 2600, the second quartz sheet 2700 and the third quartz sheet 2800 may be combined by thermal bonding. In some examples, the first quartz sheet 2600, the second quartz sheet 2700 and the third quartz sheet 2800 may be combined by high-temperature thermal compression bonding or low-temperature bonding. In some other examples, the first quartz sheet 2600, the second quartz sheet 2700 and the third quartz sheet 2800 may be further combined by an adhesive.

In some examples, the first quartz sheet 2600, the second quartz sheet 2700 and the third quartz sheet 2800 may be bonded by the following steps: cleaning the first quartz sheet 2600, the second quartz sheet 2700 and the third quartz sheet 2800; thermal compressively prebonding the first quartz sheet 2600, the second quartz sheet 2700 and the third quartz sheet 2800 in a low-temperature environment; and high-temperature thermal compressively connecting the first quartz sheet 2600, the second quartz sheet 2700 and the third quartz sheet 2800 in a high-temperature environment.

In some examples, cleaning may be RCA standard cleaning or megasonic cleaning and the like. In some examples, the low-temperature environment may be 200° C. to 500° C. In some examples, an air pressure for the thermal compression prebonding may be 1 Bar to 50 Bar. In some examples, the processing time of the thermal compression prebonding may be 5 to 100 min. In some examples, the temperature of high-temperature environment may be 900° C. to 1200° C. In some examples, the processing time of high-temperature annealing for consolidation may be 1 hour to 4 hours.

In some examples, in the laminated body 2900, axes of the grooves in the groove array may be perpendicular to the upper surface of the third quartz sheet 2800, and axes of the through holes in the through hole array may be perpendicular to the upper surface of the third quartz sheet 2800.

FIG. 8E schematically shows that bosses are fabricated on the laminated body 2900 according to various embodiments of the present disclosure.

As mentioned above, in the step S250 of the present embodiment, a plurality of bosses may be fabricated on the laminated body 2900. Specifically, the plurality of bosses (in an embodiment as shown in FIG. 8E, one of the plurality of bosses is marked as 2901) may be fabricated on positions corresponding to all the through holes in the upper surface of the first quartz sheet 2600 of the laminated body 2900. In an embodiment as shown in FIG. 6, the plurality of bosses may be a boss array.

In some examples, the bosses in the boss array may be cylindrical bosses or prismatic bosses. In some examples, each of all the bosses in the boss array may be coaxial with the corresponding one of all the through holes in the through hole array.

In some examples, the bosses in the boss array may have the same height. In some examples, the heights of the bosses in the boss array may range from 0.5 mm to 1.5 mm.

In some examples, the bosses in the boss array may have the same diameter. In some examples, the diameters of all the bosses may be smaller than the diameters of all the microcavities. In some examples, the diameters of the bosses in the boss array may range from 100 μm to 2.5 mm.

In some examples, in the laminated body 2900, the plurality of grooves and the plurality of bosses are respectively disposed on the side where the lower surface of the second quartz sheet 2700 is located and the side where the upper surface of the first quartz sheet 2600 is located, and all the through holes respectively penetrate through all the bosses.

Specifically, the grooves in the groove array, the through holes in the through hole array and the bosses in the boss array are respectively and correspondingly coaxial by the positioning holes, and the through holes in the through hole array penetrate through the bosses in the boss array.

In some examples, the boss array may be fabricated in the upper surface of the first quartz sheet 2600 by using a laser cutting process. For example, a plurality of bosses having the same height and diameter in the boss array may be fabricated on the upper surface of the first quartz sheet 2600 by computer numerical control machining (CNC machining).

In various embodiments, the bosses in the above-mentioned boss array may facilitate the welding of the fiber-optic 221 on the sensing unit 210.

As mentioned above, in the step S260 of the present embodiment, the laminated body 2900 is cut to obtain a plurality of sensing units 210. For examples, the laminated body 2900 is longitudinally cut around the periphery of the boss 2901 in FIG. 8E, and the sensing unit 210 obtained by cutting is shown as FIG. 6B. In some examples, a predetermined cutting diameter is greater than the diameter of each of the grooves and is not greater than the axle distance between the adjacent through holes.

Although the present disclosure has been specifically described as above with reference to the accompanying drawings and the examples, it may be understood that the present disclosure is not limited by the above-mentioned description in any form. The present disclosure may be varied and changed as required by the skilled in the art without departing from the essential spirit and scope of the present disclosure.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Unless indicated otherwise, not all steps listed in the various figures need be carried out in the specific order described.

The disclosure claimed is:

1. A method for preparing a sensing unit of a fiber-optic Fabry-Perot pressure sensor, comprising the steps of:
preparing a first quartz sheet with an upper surface and a lower surface and a second quartz sheet with an upper surface and a lower surface, polishing the upper surface of the first quartz sheet, and polishing the upper surface of the second quartz sheet;
fabricating a plurality of grooves in the upper surface of the first quartz sheet;
fabricating through holes in the lower surface of the first quartz sheet, each of the through holes being coaxial with a corresponding groove of the plurality of the grooves and communicating with the corresponding groove of the plurality of the grooves;
combining the upper surface of the second quartz sheet with the upper surface of the first quartz sheet in a manner of covering the plurality of grooves to form a laminated body; and
cutting the laminated body at the plurality of grooves to obtain a plurality of sensing units.

2. The method of claim 1, wherein bosses are fabricated on the lower surface of the first quartz sheet of the laminated body, each of the bosses being coaxial with a corresponding through hole of the through holes.

3. The method of claim 1, wherein, in the laminated body, axes of the through holes are perpendicular to the upper surface of the second quartz sheet.

4. The method of claim 1, wherein a plurality of air holes are fabricated in the lower surface of the second quartz sheet of the laminated body, each of the plurality of the air holes communicating with a corresponding groove of the plurality of the grooves.

5. A fiber-optic Fabry-Perot pressure sensor comprising a sensing unit prepared by the method of claim 1 and a fiber-optic, wherein:
the sensing unit comprises a first inner surface, a second inner surface opposite to the first inner surface, a cavity formed between the first inner surface and the second inner surface, and a through hole communicating with the cavity via the second inner surface;
a size of the fiber-optic matches a size of the through hole and the fiber-optic is embedded in the through hole;
an axis of the fiber-optic is orthogonal to the first inner surface and an end surface of the fiber-optic is parallel to the first inner surface, the end of the fiber-optic being embedded in the through hole; and
a light ray entering the cavity via the fiber-optic is reflected between the end surface of the fiber-optic and the first inner surface.

6. A method for preparing a sensing unit of a fiber-optic Fabry-Perot pressure sensor, comprising the steps of:
preparing a first quartz sheet with an upper surface and a lower surface, a second quartz sheet with an upper surface and a lower surface, and a third quartz sheet with an upper surface and a lower surface;
polishing the upper surface of the first quartz sheet, polishing the upper surface and the lower surface of the second quartz sheet, and polishing the upper surface of the third quartz sheet;
fabricating a plurality of grooves in the upper surface of the first quartz sheet or the upper surface of the second quartz sheet in a predetermined distribution manner;
fabricating a plurality of through holes in the third quartz sheet in the predetermined distribution manner;
combining the upper surface of the second quartz sheet with the upper surface of the first quartz sheet in a manner of covering the plurality of grooves and combining the upper surface of the third quartz sheet with the lower surface of the second quartz sheet, thereby forming a laminated body of which all the grooves and all the through holes are respectively coaxial; and
cutting the laminated body at the plurality of grooves to obtain a plurality of sensing units.

7. The method of claim 6, wherein the predetermined distribution manner comprises an axial distance between grooves.

8. The method of claim 6, further comprising fabricating bosses on the lower surface of the third quartz sheet of the laminated body, wherein:
each of the bosses is coaxial with a corresponding through hole of the through holes;
the bosses are cylindrical; and
diameters of the bosses are smaller than 2.5 mm.

9. The method of claim 6, wherein a plurality of air holes passing by the first quartz sheet and communicating with the grooves are fabricated in the laminated body.

10. The method of claim 9, wherein the plurality of air holes are L-shaped.

11. The method of claim 9, wherein the plurality of air holes are uniformly disposed around axes of the through holes.

12. A fiber-optic Fabry-Perot pressure sensor, comprising a sensing unit prepared by the method of claim 6 and a fiber-optic, wherein:
the sensing unit comprises a first diaphragm, a second diaphragm, and a third diaphragm which are sequentially laminated;
a microcavity is formed between the first diaphragm and the second diaphragm, a first reflecting surface and a second reflecting surface being respectively located on two opposite sides of the microcavity and being parallel to each other;
a through hole coaxial with the microcavity and not communicating with the microcavity is formed in the third diaphragm;
a size of the fiber-optic matches a size of the through hole and the fiber-optic is embedded in the through hole;
an axis of the fiber-optic is orthogonal to the first reflecting surface and the second reflecting surface; and
a light ray entering the microcavity via the fiber-optic is reflected between the first reflecting surface and the second reflecting surface.

13. The fiber-optic Fabry-Perot pressure sensor of claim 12, wherein:
the fiber-optic comprises a naked fiber-optic and a glass tube with a hollow part, a size of the glass tube matches a size of the through hole, and the glass tube is embedded in the through hole;
a size of the naked fiber-optic matches a size of the hollow part and the naked fiber-optic is embedded in the hollow part;
an axis of the hollow part is orthogonal to the first reflecting surface and the second reflecting surface; and
an end surface of the naked fiber-optic is parallel to the first reflecting surface and the second reflecting surface, the end of the naked fiber-optic being embedded in the hollow part.

14. The fiber-optic Fabry-Perot pressure sensor of claim 12, wherein an end surface of the fiber-optic is provided with a collimating element configured to collimate a light ray, the end of the fiber-optic being embedded in a hollow part of a glass tube.
